(19) United States
(12) Patent Application Publication
(10) Pub. No.: US 2026/0303828 A1
(43) Pub. Date: Oct. 1, 2026

(54) DYNAMIC CONFIGURATION ARCHITECTURE BASED ON COMPARING SPEEDS OF VIDEO PROCESSING ENGINES

(71) Applicant: QUALCOMM Incorporated, San Diego, CA (US)

(72) Inventors: Shengqi Yang, Carlsbad, CA (US); Haifeng Xu, San Diego, CA (US)

(21) Appl. No.: 19/091,412

(22) Filed: Mar. 26, 2025

(51) Int. Cl. H04N 19/156; H04N 19/436

(52) U.S. Cl. CPC H04N 19/156; H04N 19/436

(57) ABSTRACT

An apparatus for coding video data includes N video syntax processing (VSP) engines configured to process the video data at a syntax element level, where N is an integer greater than or equal to 2. The apparatus further includes a video pixel processing (VPP) engine configured to process the video data at a pixel level. The apparatus further includes a controller configured to: determine a VSP speed (Svsp) of one VSP engine of the N VSP engines; determine a VPP speed (Svpp) of the VPP engine; compare Svsp and Svpp; and control power of the N VSP engines based on comparing Svsp and Svpp.

### TECHNICAL FIELD

This disclosure relates to video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), ITU-T H.265/High Efficiency Video Coding (HEVC), ITU-T H.266/Versatile Video Coding (VVC), and extensions of such standards, as well as proprietary video codecs/formats such as AOMedia Video 1 (AV1) that was developed by the Alliance for Open Media. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

Certain applications, such as video transcoding or editing, demand significant processing power from video hardware. These applications often involve multiple video decoding and encoding sessions, e.g., to make quality or artificial intelligence (AI) based feature enhancements, upscaling or downscaling to desired resolution, and then re-encoding edited video to a bitstream. Performing multiple encoding and decoding sessions may result in high bitrates.

### SUMMARY

In general, this disclosure describes techniques for video encoding and decoding, including techniques for reducing power consumption and improving resource utilization efficiency in a video encoder and/or video decoder. In some examples, video codec cores may include two main processing engines: a plurality of video syntax processing (VSP) engines, and a video pixel processing (VPP) engine. The VSP engines may be configured to encode and decode syntax elements and includes processing engines to perform arithmetic coding, such as context adaptive binary arithmetic coding (CABAC). The VPP engine may be configured for pixel processing and may include engines for transforms, prediction, filtering, and other processes at the pixel level. In some examples, the power for each of the VSP engines and the VPP engine may be controlled individually in a video coding system. That is, the VSP engines and the VPP engine may be independently powered on and off.

This disclosure describes techniques that include controlling the power state of at least one VSP engine of a plurality of parallel VSP engines based on a comparison of VSP and VPP engine speeds for a video coding session. By comparing the VSP and VPP engine speeds, the system optimizes the number of active VSP engines to the processing speed of the VPP engine, thereby reducing power consumption without sacrificing performance.

One advantage of this approach is the independent control of the power state of one or more VSP engines. This flexibility allows the system to align the processing capabilities of the VSP engines and VPP engine, ensuring efficient resource utilization. Multiple VSP engines may be utilized to enhance performance in high bitrate scenarios. However, the VPP engine can become a bottleneck if processing speed of the VSP engines is faster than processing speed of the VPP engine for a coding session, resulting in underutilization of one or more VSP engines. According to techniques of this disclosure, the system can deactivate unnecessary VSP engines, leading to power savings.

The techniques of this disclosure may be particularly beneficial for high bit rate applications, such as video editing and transcoding. By dynamically configuring the VSP engines to match VPP processing speed, the video coding system maintains throughput requirements while minimizing power usage. This results in a more efficient video coding process, which is beneficial for mobile and battery-powered devices. The techniques of this disclosure may also lower thermal operating temperature for video coding devices.

The disclosed techniques provide a dynamic solution that adapts to varying video bitrates and/or pixel throughputs, enhancing energy efficiency. This adaptability not only improves user experience in demanding applications but also extends the operational life of devices by conserving power.

In an example, this disclosure describes an apparatus configured to code video data. The apparatus includes N VSP engines configured to process the video data at a syntax element level, where N is an integer greater than or equal to 2. The apparatus further includes a VPP engine configured to process the video data at a pixel level. The apparatus further includes a controller configured to: determine a VSP speed (Svsp) of one VSP engine of the N VSP engines; determine a VPP speed (Svpp) of the VPP engine; compare Svsp and Svpp; and control power of the N VSP engines based on comparing Svsp and Svpp.

In another example, this disclosure describes a method for coding video data. The method includes: processing the video data at a syntax element level using N VSP engines, where N is an integer greater than or equal to 2; processing the video data at a pixel level using a VPP engine; determining Svsp of one VSP engine of the N VSP engines; determining Svpp of the VPP engine; comparing Svsp and Svpp; and controlling power of the N VSP engines based on comparing Svsp and Svpp.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video encoding and decoding system that may perform the techniques of this disclosure.

FIG. 2 is a block diagram illustrating an example video encoder that may perform the techniques of this disclosure.

FIG. 3 is a block diagram illustrating an example video decoder that may perform the techniques of this disclosure.

FIG. 4 illustrates example use cases of a VSP engine and a VPP engine operating on different frames of video data.

FIG. 5 is a block diagram illustrating an example of video hardware, including a plurality of VSP engines and a VPP engine, controlled by a controller.

FIG. 6 is a block diagram illustrating an example scenario of the video hardware of FIG. 5 being controlled by the controller based on a speed of the VPP engine being less than or equal to a speed of one VSP engine.

FIG. 7 is a block diagram illustrating an example scenario of the video hardware of FIG. 5 being controlled by the controller based on a speed of the VPP engine being greater than or equal to a speed of N VSP engines, where N is a total number of VSP engines.

FIG. 8 is a block diagram illustrating an example scenario of the video hardware of FIG. 5 being controlled by the controller based on a speed of the VPP engine being less than a speed of N VSP engines but greater than a speed of N/2 VSP engines.

FIG. 9 is a flowchart illustrating an example of controlling power of one or more VSP engines based on a comparison of VSP and VPP engine speeds for a video coding session.

FIG. 10 is a flowchart illustrating an example of comparing VSP and VPP engine speeds for a video coding session and controlling power of one or more VSP engines based on said comparison.

### DETAILED DESCRIPTION

Certain applications, such as video transcoding or editing, demand significant processing power from video hardware. These applications often involve multiple video decoding and encoding sessions, e.g., to make quality or artificial intelligence (AI) based feature enhancements, upscaling or downscaling to desired resolution, and then re-encoding edited video to a bitstream. Performing multiple encoding and decoding sessions may result in high bitrates. This creates a challenge in efficiently managing hardware resources to maintain performance while minimizing power consumption.

As described above, video hardware may include a plurality of bitstream processing engines (e.g., VSP engines) and one or more pixel processing pipes (e.g., a VPP engine). In this disclosure, the term “VPP engine” is used to describe a single pixel processing pipe or a plurality of pixel processing pipes working together (e.g., operating in parallel) to process video data. Thus, in some examples, the VPP engine may comprise a plurality of VPP pipes/engines even though singular form of the term “VPP engine” may be used.

Performance of a VSP engine may be determined by bitrate, while performance of the VPP engine may be determined by pixel throughput. To improve performance in high bitrate scenarios, the video hardware of a video coding system may include multiple VSP engines configured process video data in parallel. However, the VPP engine can become a bottleneck if the VSP engines outpace the VPP engine during a coding session, resulting in underutilization of one or more VSP engines. This inefficiency results in unnecessary power consumption, as all the VSP engines may remain active (e.g., turned on) for an entire coding session even when some of the VSP engines are not processing syntax elements during the coding session or at least a portion thereof.

The techniques of this disclosure address these challenges by dynamically adjusting the number of active VSP engines based on a comparison of VSP and VPP engine speeds for a video coding session. By determining the number of VSP engines needed to match the throughput of the VPP engine, a video coding system can deactivate unnecessary VSP engines, thereby reducing power consumption.

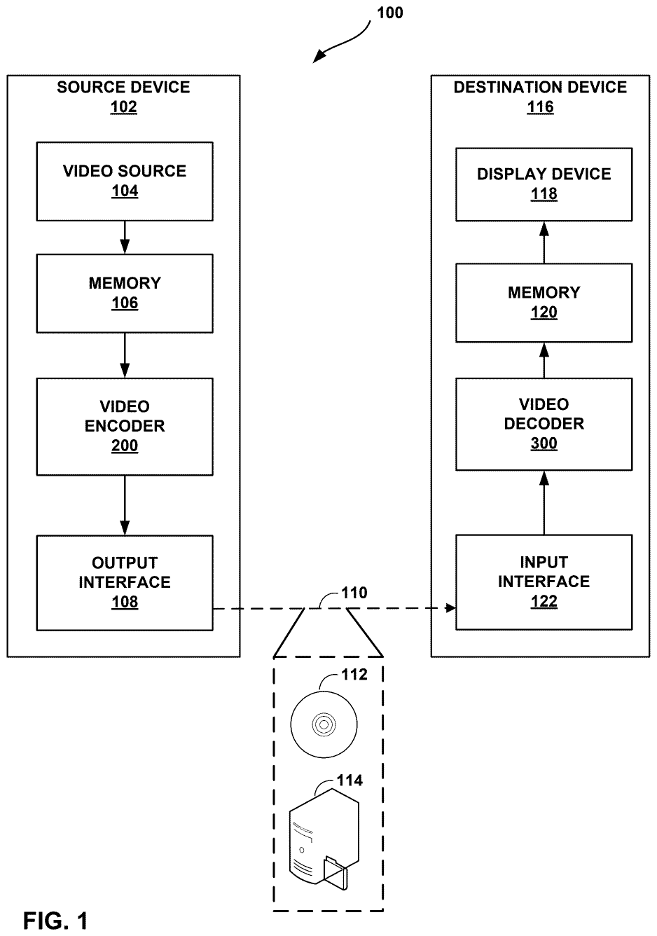

FIG. 1 is a block diagram illustrating an example video encoding and decoding system 100 that may perform the techniques of this disclosure. The techniques of this disclosure are generally directed to architectures for coding (encoding and/or decoding) video data. In general, video data includes any data for processing a video. Thus, video data may include raw, unencoded video, encoded video, decoded (e.g., reconstructed) video, depth buffers, alpha channels, and video metadata, such as signaling data.

As shown in FIG. 1, system 100 includes a source device 102 that provides encoded video data to be decoded and displayed by a destination device 116, in this example. In particular, source device 102 provides the video data to destination device 116 via a computer-readable medium 110. Source device 102 and destination device 116 may be or include any of a wide range of devices, such as desktop computers, notebook (i.e., laptop) computers, mobile devices, tablet computers, set-top boxes, telephone handsets such as VR headsets, AR glasses, head mounted displays (HMDs), smartphones, televisions, cameras, display devices, digital media players, video gaming consoles, video streaming device, broadcast receiver devices, or the like. In some cases, source device 102 and destination device 116 may be equipped for wireless communication, and thus may be referred to as wireless communication devices.

In the example of FIG. 1, source device 102 includes video source 104, memory 106, video encoder 200, and output interface 108. Destination device 116 includes input interface 122, video decoder 300, memory 120, and display device 118. In accordance with this disclosure, video encoder 200 of source device 102 and video decoder 300 of destination device 116 may be configured to apply the techniques for coding video data using independently power controlled syntax and pixel processing engines. Thus, source device 102 represents an example of a video encoding device, while destination device 116 represents an example of a video decoding device. In other examples, a source device and a destination device may include other components or arrangements. For example, source device 102 may receive video data from an external video source, such as an external camera. Likewise, destination device 116 may interface with an external display device, rather than include an integrated display device.

System 100 as shown in FIG. 1 is merely one example. In general, any digital video encoding and/or decoding device may perform techniques for coding video data using independently power controlled syntax and pixel processing engines. Source device 102 and destination device 116 are merely examples of such coding devices in which source device 102 generates coded video data for transmission to destination device 116. This disclosure refers to a “coding” device as a device that performs coding (encoding and/or decoding) of data. Thus, video encoder 200 and video decoder 300 represent examples of coding devices, in particular, a video encoder and a video decoder, respectively. In some examples, source device 102 and destination device 116 may operate in a substantially symmetrical manner such that each of source device 102 and destination device 116 includes video encoding and decoding components. Hence, system 100 may support one-way or two-way video transmission between source device 102 and destination device 116, e.g., for video streaming, video playback, video broadcasting, XR real-time gaming, split rendering, or video telephony.

In general, video source 104 represents a source of video data (i.e., raw, unencoded video data) and provides a sequential series of pictures (also referred to as “frames”) of the video data to video encoder 200, which encodes data for the pictures. Video source 104 of source device 102 may include a video capture device, such as a video camera, a video archive containing previously captured raw video, and/or a video feed interface to receive video from a video content provider. As a further alternative, video source 104 may generate computer graphics-based data as the source video, or a combination of live video, archived video, and computer-generated video. In each case, video encoder 200 encodes the captured, pre-captured, or computer-generated video data. Video encoder 200 may rearrange the pictures from the received order (sometimes referred to as “display order”) into a coding order for coding. Video encoder 200 may generate a bitstream including encoded video data. Source device 102 may then output the encoded video data via output interface 108 onto computer-readable medium 110 for reception and/or retrieval by, e.g., input interface 122 of destination device 116.

Memory 106 of source device 102 and memory 120 of destination device 116 represent general purpose memories. In some examples, memories 106, 120 may store raw video data, e.g., raw video from video source 104 and raw, decoded video data from video decoder 300. Additionally or alternatively, memories 106, 120 may store software instructions executable by, e.g., video encoder 200 and video decoder 300, respectively. Although memory 106 and memory 120 are shown separately from video encoder 200 and video decoder 300 in this example, it should be understood that video encoder 200 and video decoder 300 may also include internal memories for functionally similar or equivalent purposes. Furthermore, memories 106, 120 may store encoded video data, e.g., output from video encoder 200 and input to video decoder 300. In some examples, portions of memories 106, 120 may be allocated as one or more video buffers, e.g., to store raw, decoded, and/or encoded video data.

Computer-readable medium 110 may represent any type of medium or device capable of transporting the encoded video data from source device 102 to destination device 116. In one example, computer-readable medium 110 represents a communication medium to enable source device 102 to transmit encoded video data directly to destination device 116 in real-time, e.g., via a radio frequency network or computer-based network. Output interface 108 may modulate a transmission signal including the encoded video data, and input interface 122 may demodulate the received transmission signal, according to a communication standard, such as a wireless communication protocol. The communication medium may include any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded video data.

In some examples, source device 102 may output encoded video data to file server 114 or another intermediate storage device that may store the encoded video data generated by source device 102. Destination device 116 may access stored video data from file server 114 via streaming or download.

File server 114 may be any type of server device capable of storing encoded video data and transmitting that encoded video data to the destination device 116. File server 114 may represent a web server (e.g., for a website), a server configured to provide a file transfer protocol service (such as File Transfer Protocol (FTP) or File Delivery over Unidirectional Transport (FLUTE) protocol), a content delivery network (CDN) device, a hypertext transfer protocol (HTTP) server, a Multimedia Broadcast Multicast Service (MBMS) or Enhanced MBMS (eMBMS) server, and/or a network attached storage (NAS) device. File server 114 may, additionally or alternatively, implement one or more HTTP streaming protocols, such as Dynamic Adaptive Streaming over HTTP (DASH), HTTP Live Streaming (HLS), Real Time Streaming Protocol (RTSP), HTTP Dynamic Streaming, or the like.

Destination device 116 may access encoded video data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded video data stored on file server 114. Input interface 122 may be configured to operate according to any one or more of the various protocols discussed above for retrieving or receiving media data from file server 114, or other such protocols for retrieving media data.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 include wireless components, output interface 108 and input interface 122 may be configured to transfer data, such as encoded video data, according to a cellular communication standard, such as 4G, 4G-LTE (Long-Term Evolution), LTE Advanced, 5G, or the like. In some examples where output interface 108 includes a wireless transmitter, output interface 108 and input interface 122 may be configured to transfer data, such as encoded video data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to video encoder 200 and/or output interface 108, and destination device 116 may include an SoC device to perform the functionality attributed to video decoder 300 and/or input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), real-time transport protocol (RTP), digital video that is encoded onto a data storage medium, decoding of digital video stored on a data storage medium, or other applications.

Input interface 122 of destination device 116 receives an encoded video bitstream from computer-readable medium 110 (e.g., a communication medium, storage device 112, file server 114, or the like). The encoded video bitstream may include signaling information defined by video encoder 200, which is also used by video decoder 300, such as syntax elements having values that describe characteristics and/or processing of video blocks or other coded units (e.g., slices, pictures, groups of pictures, sequences, or the like). Display device 118 displays decoded pictures of the decoded video data to a user. Display device 118 may represent any of a variety of display devices such as a liquid crystal display (LCD), a plasma display, an organic light emitting diode (OLED) display, or another type of display device.

Although not shown in FIG. 1, in some examples, video encoder 200 and video decoder 300 may each be integrated with an audio encoder and/or audio decoder (e.g., audio codec), and may include appropriate MUX-DEMUX units, or other hardware and/or software, to handle multiplexed streams including both audio and video in a common data stream. Example audio codecs may include AAC, AC-3, AC-4, ALAC, ALS, AMBE, AMR, AMR-WB (G.722.2), AMR-WB+, aptx (various versions), ATRAC, Broad Voice (BV16, BV32), CELT, Enhanced AC-3 (E-AC-3), EVS, FLAC, G.711, G.722, G.722.1, G.722.2 (AMR-WB). G.723.1, G.726, G.728, G.729, G.729.1, GSM-FR, HE-AAC, iLBC, iSAC, LA Lyra, Monkey's Audio, MP1, MP2 (MPEG-1, 2 Audio Layer II), MP3, Musepack, Nellymoser Asao, OptimFROG, Opus, Sac, Satin, SBC, SILK, Siren 7, Speex, SVOPC, True Audio (TTA), TwinVQ, USAC, Vorbis (Ogg), WavPack, and Windows Media Aud.

Video encoder 200 and video decoder 300 each may be implemented as any of a variety of suitable encoder and/or decoder circuitry that includes a processing system, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 200 and video decoder 300 may be included in one or more encoders or decoders, either of which may be integrated as part of a combined encoder/decoder (CODEC) in a respective device. A device including video encoder 200 and/or video decoder 300 may implement video encoder 200 and/or video decoder 300 in processing circuitry such as an integrated circuit and/or a microprocessor. Such a device may be a wireless communication device, such as a cellular telephone, or any other type of device described herein.

As will be described in more detail below, video encoder 200 and video decoder 300 may each include a plurality of VSP engines and a VPP engine. Video encoder 200 and video decoder 300 may each include a controller that may, among other things, independently control the on/off power states of the VSP engines and (optionally) the VPP engine. In general, the VSP engines may be configured to process video data at the syntax element level, and may perform tasks such as entropy coding (e.g., CABAC). The VPP engine may be configured to process video data at the pixel level, and may perform tasks such as transform, prediction, and filtering.

Video encoder 200 and video decoder 300 may operate according to a video coding standard, such as ITU-T H.265, also referred to as High Efficiency Video Coding (HEVC) or extensions thereto, such as the multi-view and/or scalable video coding extensions. Alternatively, video encoder 200 and video decoder 300 may operate according to other proprietary or industry standards, such as ITU-T H.266, also referred to as Versatile Video Coding (VVC). In other examples, video encoder 200 and video decoder 300 may operate according to a proprietary video codec/format, such as AOMedia Video 1 (AV1), extensions of AV1, and/or successor versions of AV1 (e.g., AV2). In other examples, video encoder 200 and video decoder 300 may operate according to other proprietary formats or industry standards. The techniques of this disclosure, however, are not limited to any particular coding standard or format. In general, video encoder 200 and video decoder 300 may be configured to perform the techniques of this disclosure in conjunction with any video coding techniques that code video data using independently power controlled syntax and pixel processing engines.

In general, video encoder 200 and video decoder 300 may perform block-based coding of pictures. The term “block” generally refers to a structure including data to be processed (e.g., encoded, decoded, or otherwise used in the encoding and/or decoding process). For example, a block may include a two-dimensional matrix of samples of luminance and/or chrominance data. In general, video encoder 200 and video decoder 300 may code video data represented in a YUV (e.g., Y, Cb, Cr) format. That is, rather than coding red, green, and blue (RGB) data for samples of a picture, video encoder 200 and video decoder 300 may code luminance and chrominance components, where the chrominance components may include both red hue and blue hue chrominance components. In some examples, video encoder 200 converts received RGB formatted data to a YUV representation prior to encoding, and video decoder 300 converts the YUV representation to the RGB format. Alternatively, pre- and post-processing units (not shown) may perform these conversions. Video data may further include depth channels and/or alpha channels, which are not visual YUV channels, but may be interpreted as Y channels for coding purposes. In other examples, YUV video data may be combined with other 2D non-visual data that can benefit from video coding.

This disclosure may generally refer to coding (e.g., encoding and decoding) of pictures to include the process of encoding or decoding data of the picture. Similarly, this disclosure may refer to coding of blocks of a picture to include the process of encoding or decoding data for the blocks, e.g., prediction and/or residual coding. An encoded video bitstream generally includes a series of values for syntax elements representative of coding decisions (e.g., coding modes) and partitioning of pictures into blocks. Thus, references to coding a picture or a block should generally be understood as coding values for syntax elements forming the picture or block.

HEVC defines various blocks, including coding units (CUs), prediction units (PUs), and transform units (TUs). According to HEVC, a video coder (such as video encoder 200) partitions a coding tree unit (CTU) into CUs according to a quadtree structure. That is, the video coder partitions CTUs and CUs into four equal, non-overlapping squares, and each node of the quadtree has either zero or four child nodes. Nodes without child nodes may be referred to as “leaf nodes,” and CUs of such leaf nodes may include one or more PUs and/or one or more TUs. The video coder may further partition PUs and TUs. For example, in HEVC, a residual quadtree (RQT) represents partitioning of TUs. In HEVC, PUs represent inter-prediction data, while TUs represent residual data. CUs that are intra-predicted include intra-prediction information, such as an intra-mode indication.

As another example, video encoder 200 and video decoder 300 may be configured to operate according to VVC. According to VVC, a video coder (such as video encoder 200) partitions a picture into a plurality of CTUs. Video encoder 200 may partition a CTU according to a tree structure, such as a quadtree-binary tree (QTBT) structure or Multi-Type Tree (MTT) structure. The QTBT structure removes the concepts of multiple partition types, such as the separation between CUs, PUs, and TUs of HEVC. A QTBT structure includes two levels: a first level partitioned according to quadtree partitioning, and a second level partitioned according to binary tree partitioning. A root node of the QTBT structure corresponds to a CTU. Leaf nodes of the binary trees correspond to CUs.

In an MTT partitioning structure, blocks may be partitioned using a quadtree (QT) partition, a binary tree (BT) partition, and one or more types of triple tree (TT) (also called ternary tree (TT)) partitions. A triple or ternary tree partition is a partition where a block is split into three sub-blocks. In some examples, a triple or ternary tree partition divides a block into three sub-blocks without dividing the original block through the center. The partitioning types in MTT (e.g., QT, BT, and TT), may be symmetrical or asymmetrical.

When operating according to the AV1 codec, video encoder 200 and video decoder 300 may be configured to code video data in blocks. In AV1, the largest coding block that can be processed is called a superblock. In AV1, a superblock can be either 128×128 luma samples or 64×64 luma samples. However, in successor video coding formats (e.g., AV2), a superblock may be defined by different (e.g., larger) luma sample sizes. In some examples, a superblock is the top level of a block quadtree. Video encoder 200 may further partition a superblock into smaller coding blocks. Video encoder 200 may partition a superblock and other coding blocks into smaller blocks using square or non-square partitioning. Non-square blocks may include N/2×N, N×N/2, N/4×N, and N×N/4 blocks. Video encoder 200 and video decoder 300 may perform separate prediction and transform processes on each of the coding blocks.

AV1 also defines a tile of video data. A tile is a rectangular array of superblocks that may be coded independently of other tiles. That is, video encoder 200 and video decoder 300 may encode and decode, respectively, coding blocks within a tile without using video data from other tiles. However, video encoder 200 and video decoder 300 may perform filtering across tile boundaries. Tiles may be uniform or non-uniform in size. Tile-based coding may enable parallel processing and/or multi-threading for encoder and decoder implementations.

In some examples, video encoder 200 and video decoder 300 may use a single QTBT or MTT structure to represent each of the luminance and chrominance components, while in other examples, video encoder 200 and video decoder 300 may use two or more QTBT or MTT structures, such as one QTBT/MTT structure for the luminance component and another QTBT/MTT structure for both chrominance components (or two QTBT/MTT structures for respective chrominance components).

Video encoder 200 and video decoder 300 may be configured to use quadtree partitioning, QTBT partitioning, MTT partitioning, superblock partitioning, or other partitioning structures.

In some examples, a CTU includes a coding tree block (CTB) of luma samples, two corresponding CTBs of chroma samples of a picture that has three sample arrays, or a CTB of samples of a monochrome picture or a picture that is coded using three separate color planes and syntax structures used to code the samples. A CTB may be an N×N block of samples for some value of N such that the division of a component into CTBs is a partitioning. A component is an array or single sample from one of the three arrays (luma and two chroma) that compose a picture in 4:2:0, 4:2:2, or 4:4:4 color format or the array or a single sample of the array that compose a picture in monochrome format. In some examples, a coding block is an M×N block of samples for some values of M and N such that a division of a CTB into coding blocks is a partitioning.

The blocks (e.g., CTUs or CUs) may be grouped in various ways in a picture. As one example, a brick may refer to a rectangular region of CTU rows within a particular tile in a picture. A tile may be a rectangular region of CTUs within a particular tile column and a particular tile row in a picture. A tile column refers to a rectangular region of CTUs having a height equal to the height of the picture and a width specified by syntax elements (e.g., such as in a picture parameter set). A tile row refers to a rectangular region of CTUs having a height specified by syntax elements (e.g., such as in a picture parameter set) and a width equal to the width of the picture.

In some examples, a tile may be partitioned into multiple bricks, each of which may include one or more CTU rows within the tile. A tile that is not partitioned into multiple bricks may also be referred to as a brick. However, a brick that is a true subset of a tile may not be referred to as a tile. The bricks in a picture may also be arranged in a slice. A slice may be an integer number of bricks of a picture that may be exclusively contained in a single network abstraction layer (NAL) unit. In some examples, a slice includes either a number of complete tiles or only a consecutive sequence of complete bricks of one tile.

This disclosure may use “N×N” and “N by N” interchangeably to refer to the sample dimensions of a block (such as a CU or other video block) in terms of vertical and horizontal dimensions, e.g., 16×16 samples or 16 by 16 samples. In general, a 16×16 CU will have 16 samples in a vertical direction (y=16) and 16 samples in a horizontal direction (x=16). Likewise, an N×N CU generally has N samples in a vertical direction and N samples in a horizontal direction, where N represents a nonnegative integer value. The samples in a CU may be arranged in rows and columns. Moreover, CUs need not necessarily have the same number of samples in the horizontal direction as in the vertical direction. For example, CUs may include N×M samples, where M is not necessarily equal to N.

Video encoder 200 encodes video data for CUs representing prediction and/or residual information, and other information. The prediction information indicates how the CU is to be predicted in order to form a prediction block for the CU. The residual information generally represents sample-by-sample differences between samples of the CU prior to encoding and the prediction block.

To predict a CU, video encoder 200 may generally form a prediction block for the CU through inter-prediction or intra-prediction. Inter-prediction generally refers to predicting the CU from data of a previously coded picture, whereas intra-prediction generally refers to predicting the CU from previously coded data of the same picture. To perform inter-prediction, video encoder 200 may generate the prediction block using one or more motion vectors. Video encoder 200 may generally perform a motion search to identify a reference block that closely matches the CU, e.g., in terms of differences between the CU and the reference block. Video encoder 200 may calculate a difference metric using a sum of absolute difference (SAD), sum of squared differences (SSD), mean absolute difference (MAD), mean squared differences (MSD), or other such difference calculations to determine whether a reference block closely matches the current CU. In some examples, video encoder 200 may predict the current CU using uni-directional prediction or bi-directional prediction.

Some examples of VVC also provide an affine motion compensation mode, which may be considered an inter-prediction mode. In affine motion compensation mode, video encoder 200 may determine two or more motion vectors that represent non-translational motion, such as zoom in or out, rotation, perspective motion, or other irregular motion types.

To perform intra-prediction, video encoder 200 may select an intra-prediction mode to generate the prediction block. Some examples of VVC provide sixty-seven intra-prediction modes, including various directional modes, as well as planar mode and DC mode. In general, video encoder 200 selects an intra-prediction mode that describes neighboring samples to a current block (e.g., a block of a CU) from which to predict samples of the current block. Such samples may generally be above, above and to the left, or to the left of the current block in the same picture as the current block, assuming video encoder 200 codes CTUs and CUs in raster scan order (left to right, top to bottom).

Video encoder 200 encodes data representing the prediction mode for a current block. For example, for inter-prediction modes, video encoder 200 may encode data representing which of the various available inter-prediction modes is used, as well as motion information for the corresponding mode. For uni-directional or bi-directional inter-prediction, for example, video encoder 200 may encode motion vectors using advanced motion vector prediction (AMVP) or merge mode. Video encoder 200 may use similar modes to encode motion vectors for affine motion compensation mode.

AV1 includes two general techniques for encoding and decoding a coding block of video data. The two general techniques are intra prediction (e.g., intra frame prediction or spatial prediction) and inter prediction (e.g., inter frame prediction or temporal prediction). In the context of AV1, when predicting blocks of a current frame of video data using an intra prediction mode, video encoder 200 and video decoder 300 do not use video data from other frames of video data. For most intra prediction modes, video encoder 200 encodes blocks of a current frame based on the difference between sample values in the current block and predicted values generated from reference samples in the same frame. Video encoder 200 determines predicted values generated from the reference samples based on the intra prediction mode.

Following prediction, such as intra-prediction or inter-prediction of a block, video encoder 200 may calculate residual data for the block. The residual data, such as a residual block, represents sample by sample differences between the block and a prediction block for the block, formed using the corresponding prediction mode. Video encoder 200 may apply one or more transforms to the residual block, to produce transformed data in a transform domain instead of the sample domain. For example, video encoder 200 may apply a discrete cosine transform (DCT), an integer transform, a wavelet transform, or a conceptually similar transform to residual video data. Additionally, video encoder 200 may apply a secondary transform following the first transform, such as a mode-dependent non-separable secondary transform (MDNSST), a signal dependent transform, a Karhunen-Loeve transform (KLT), or the like. Video encoder 200 produces transform coefficients following application of the one or more transforms.

As noted above, following any transforms to produce transform coefficients, video encoder 200 may perform quantization of the transform coefficients. Quantization generally refers to a process in which transform coefficients are quantized to possibly reduce the amount of data used to represent the transform coefficients, providing further compression. By performing the quantization process, video encoder 200 may reduce the bit depth associated with some or all of the transform coefficients. For example, video encoder 200 may round an n-bit value down to an m-bit value during quantization, where n is greater than m. In some examples, to perform quantization, video encoder 200 may perform a bitwise right-shift of the value to be quantized.

Following quantization, video encoder 200 may scan the transform coefficients, producing a one-dimensional vector from the two-dimensional matrix including the quantized transform coefficients. The scan may be designed to place higher energy (and therefore lower frequency) transform coefficients at the front of the vector and to place lower energy (and therefore higher frequency) transform coefficients at the back of the vector. In some examples, video encoder 200 may utilize a predefined scan order to scan the quantized transform coefficients to produce a serialized vector, and then entropy encode the quantized transform coefficients of the vector. In other examples, video encoder 200 may perform an adaptive scan. After scanning the quantized transform coefficients to form the one-dimensional vector, video encoder 200 may entropy encode the one-dimensional vector, e.g., according to context-adaptive binary arithmetic coding (CABAC). Video encoder 200 may also entropy encode values for syntax elements describing metadata associated with the encoded video data for use by video decoder 300 in decoding the video data.

To perform CABAC, video encoder 200 may assign a context within a context model to a symbol to be transmitted. The context may relate to, for example, whether neighboring values of the symbol are zero-valued or not. The probability determination may be based on a context assigned to the symbol.

Video encoder 200 may further generate syntax data, such as block-based syntax data, picture-based syntax data, and sequence-based syntax data, to video decoder 300, e.g., in a picture header, a block header, a slice header, or other syntax data, such as a sequence parameter set (SPS), picture parameter set (PPS), or video parameter set (VPS). Video decoder 300 may likewise decode such syntax data to determine how to decode corresponding video data.

In this manner, video encoder 200 may generate a bitstream including encoded video data, e.g., syntax elements describing partitioning of a picture into blocks (e.g., CUs) and prediction and/or residual information for the blocks. Ultimately, video decoder 300 may receive the bitstream and decode the encoded video data.

In general, video decoder 300 performs a reciprocal process to that performed by video encoder 200 to decode the encoded video data of the bitstream. For example, video decoder 300 may decode values for syntax elements of the bitstream using CABAC in a manner substantially similar to, albeit reciprocal to, the CABAC encoding process of video encoder 200. The syntax elements may define partitioning information for partitioning of a picture into CTUs, and partitioning of each CTU according to a corresponding partition structure, such as a QTBT structure, to define CUs of the CTU. The syntax elements may further define prediction and residual information for blocks (e.g., CUs) of video data.

The residual information may be represented by, for example, quantized transform coefficients. Video decoder 300 may inverse quantize and inverse transform the quantized transform coefficients of a block to reproduce a residual block for the block. Video decoder 300 uses a signaled prediction mode (intra- or inter-prediction) and related prediction information (e.g., motion information for inter-prediction) to form a prediction block for the block. Video decoder 300 may then combine the prediction block and the residual block (on a sample-by-sample basis) to reproduce the original block. Video decoder 300 may perform additional processing, such as performing a deblocking process to reduce visual artifacts along boundaries of the block.

This disclosure may generally refer to “signaling” certain information, such as syntax elements. The term “signaling” may generally refer to the communication of values for syntax elements and/or other data used to decode encoded video data. That is, video encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

As will be explained in more detail below, this disclosure describes techniques for video encoding and decoding, including techniques for reducing power consumption in video encoder 200 and/or video decoder 300. In some examples, video codec cores in video encoder 200 and video decoder 300 may include two main processing engines: a plurality of video syntax processing (VSP) engines, and a video pixel processing (VPP) engine. The VSP engines may be configured to encode and decode syntax elements and includes processing engines to perform arithmetic coding, such as CABAC. In other examples, the VSP engines may perform other types of arithmetic coding, such as context adaptive variable length coding (CAVLC) or non-binary arithmetic coding. The techniques of this disclosure may be used with any VSP engines performing any type of arithmetic coding or coding of syntax elements. The VPP engine may be configured for pixel processing and may include engines for transforms, prediction, filtering, and other processes at the pixel level. In some examples, the power states of VSP engines and (optionally) the VPP engine may be controlled individually in a video coding system. For example, any of the VSP engines may be independently powered on and off.

In a high bitrate video coding scenario, the VPP engine may become a performance bottleneck. As such, one or more VSP engines may be underutilized (e.g., unnecessarily turned on while not processing syntax elements). This presents an opportunity to save power for power hungry video coding use cases.

This disclosure describes techniques that include controlling the power state of at least one VSP engine of a plurality of parallel VSP engines based on a comparison of VSP and VPP engine speeds for a video coding session. By comparing the VSP and VPP engine speeds, a controller of video encoder 200 and/or video decoder 300 may optimize the number of active VSP engines to the processing speed of the VPP engine, thereby reducing power consumption without sacrificing performance.

In one example, based on the bitrate of one or more video coding sessions, for a parallel architecture with multiple of VSP engines, the number of VSP engines that match the VPP engine throughput can be determined and turned on, while other VSP engines are turned off, to save power.

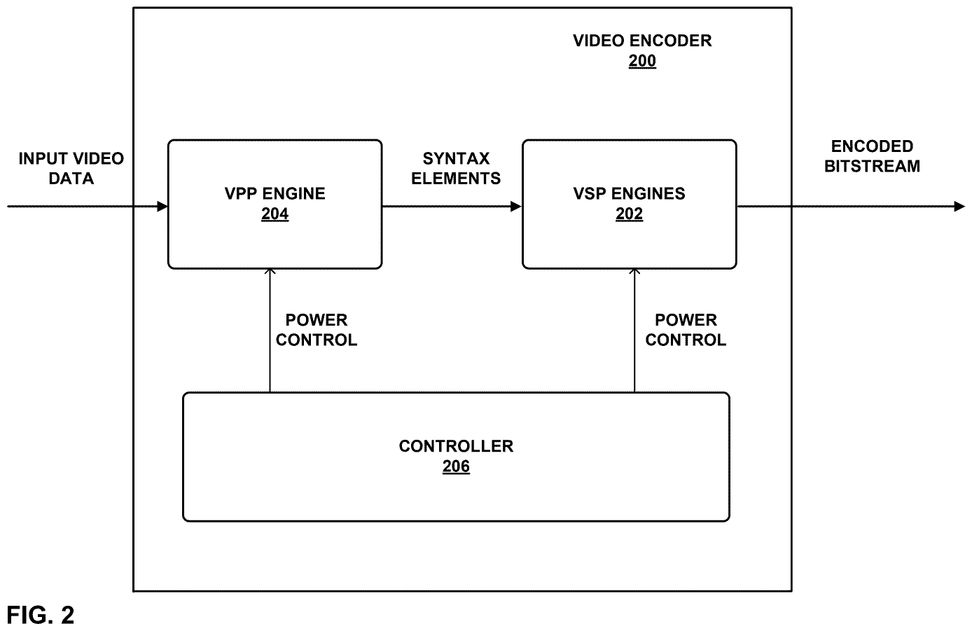

FIG. 2 is a block diagram illustrating an example video encoder that may perform the techniques of this disclosure. In the example of FIG. 2, video encoder 200 includes a VPP engine 204, a plurality of VSP engines 202, and controller 206. VPP engine 204 is configured to process input video data (e.g., frames of video data). In some examples, VPP engine 204 may comprise a plurality of VPP engines, where the plurality of VPP engines may be configured to operate on video data of a frame in parallel. For example, each VPP engine may operate on an LCU row of video data. In other examples, VPP engine 204 may comprise a single VPP engine (e.g., in a non-parallel architecture).

As mentioned above, VPP engine 204 may process video data at the pixel level. As such, the processing speed of VPP engine 204 may be described as a pixel rate (e.g., MPps, M Pixels per second). VPP engine 204 may perform pixel level video encoding processes described above, such as prediction, transformation, quantization, filtering, and related processing for reconstructing reference frames. The output of VPP engine 204 is syntax elements.

VSP engines 202 take the syntax elements as input and compresses the syntax elements to produce an encoded video bitstream. VSP engines 202 may compress the syntax elements using CABAC, other entropy coding techniques, and/or fixed probability encoding techniques. VSP engines 202 may be configured to operate on video data of a frame in parallel when multiple VSP engines are powered on. In other situations, a single VSP engine (of the plurality of VSP engines 202) may perform functions of the VSP engines 202 described herein. VSP engines 202 operate on the bit or “bin” level. The processing speed of VSP engines 202 engine is typically measured in terms of a bitrate (e.g., Mbps, M bits per second). VPP engine 204 and VSP engine 202 may exchange data through one or more memories or buffers, including faster on-chip buffers, or buffers in external memory (e.g., double data rate (DDR) RAM). In some examples, VPP engine 204 and VSP engines 202 are configured to exchange data through a ring buffer that allows VPP engine 204 and VSP engines 202 to operate on different and potentially non-Video encoder 200 may further include a controller 206 configured to control the power states of VSP engines 202 and (optionally) VPP engine 204. Controller 206 may operate according to firmware and/or may execute a software driver. As described above, controller 206 may be configured to independently power on and off any of VSP engines 202 and VPP engine 204. The techniques described below focus on how controller 206 may control the power states of VSP engines 202 to match the processing speed of VPP engine 204, thus saving power.

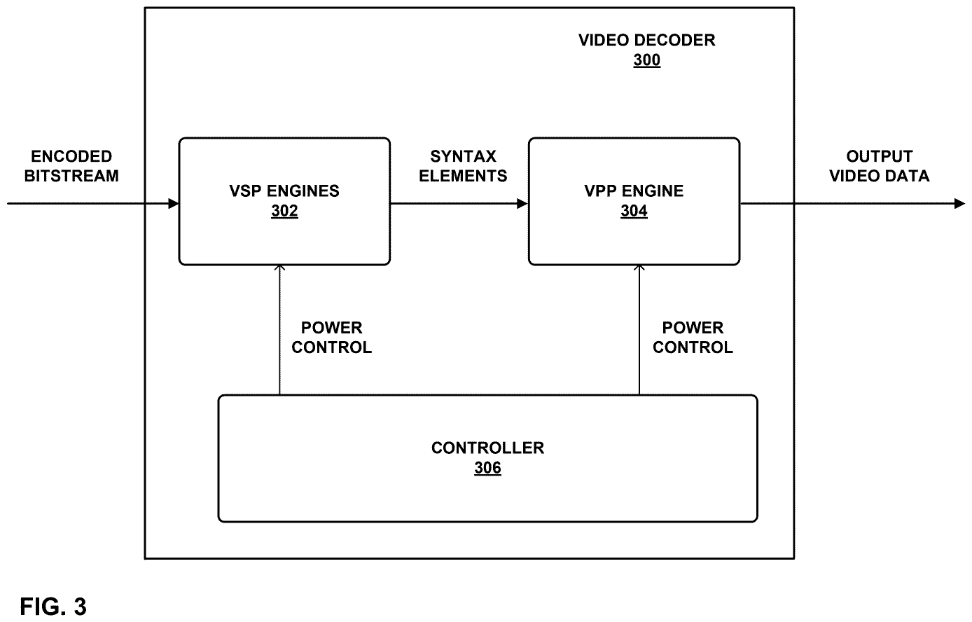

FIG. 3 is a block diagram illustrating an example video decoder that may perform the techniques of this disclosure. Video decoder 300 perform the inverse operation of video encoder 200 of FIG. 2. In the example of FIG. 3, video decoder 300 includes a plurality of VSP engines 302, a VPP engine 304, and controller 306. VSP engines 302 are configured to process an encoded video bitstream to produce syntax elements. That is, VSP engines 302 may perform entropy decoding, such as CABAC decoding, to recover the syntax elements encoded in the encoded video bitstream. VSP engines 302 may be configured to operate on video data of a frame in parallel when multiple VSP engines are powered on. In other situations, a single VSP engine (of the plurality of VSP engines 302) may perform functions of the VSP engines 302 described herein. Like VSP engines 202 of FIG. 2, VSP engines 302 may operate on the bit or “bin” level. The processing speed of VSP engines 302 is therefore typically measured in terms of a bitrate (e.g., Mbps, M bits per second).

VPP engine 204 may perform pixel level video decoding processes described above, such as prediction, inverse transformation, dequantization, filtering. The output of VPP engine 304 is output video data in the form of decoded frames. In some examples, VPP engine 304 may comprise a plurality of VPP engines, where the plurality of VPP engines may be configured to operate on video data of a frame in parallel. For example, each VPP engine may operate on an LCU row of video data. In other examples, VPP engine 304 may comprise a single VPP engine (e.g., in a non-parallel architecture).

VPP engine 304 may process video data at the pixel level. As such, the processing speed of VPP engine 304 may be described as a pixel rate (e.g., MPps, M Pixels per second). VSP engines 302 and VPP engine 304 may exchange data through one or more memories or buffers, including faster on-chip buffers, or buffers in external memory (e.g., double data rate (DDR) RAM). In some examples, VPP engine 204 and VSP engine 202 are configured to exchange data through a ring buffer that allows VPP engine 204 and VSP engines 202 to operate on different and potentially non-sequential frames of video data in parallel.

Video decoder 300 may further include a controller 306 configured to control the power states of VSP engines 302 and (optionally) VPP engine 304. Controller 306 may operate according to firmware and/or may execute a software driver. As described above, controller 306 may be configured to independently power on and off VSP engines 302 and VPP engine 304. The techniques described below focus on how controller 306 may control the power states of VSP engines 302 to match the processing speed of VPP engine 304, thus saving power.

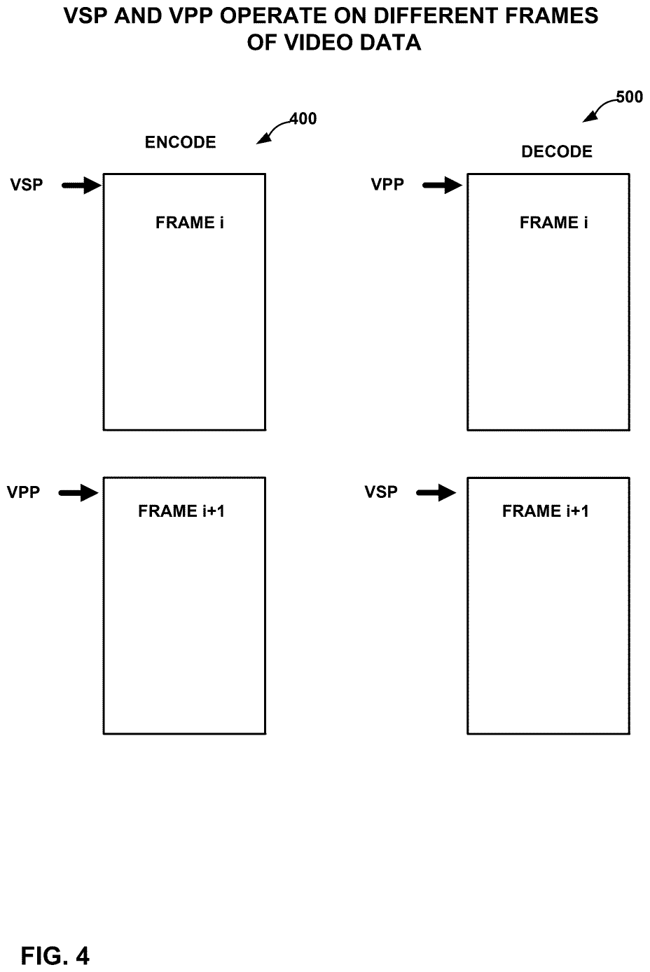

FIG. 4 illustrates example use cases of VSP and VPP engines operating on different frames of video data. In scenario 400, video encoder 200 uses one or more VSP engines and a VPP engine to encode a Frame i of video data and a Frame i+1 of video data at least partially in parallel. For example, the one or more VSP engine and the VPP engine may operate on different frames of video data at the same time. While scenario 400 shows the VPP engine operating one frame ahead (e.g., at Frame i+1) of the one or more VSP engines, in other examples, the VPP engine may operate several frames ahead of the one or more VSP engines. Scenario 400 may be called a different frame mode of video encoding.

In scenario 400, the VPP engine may completely encode (e.g., produce syntax elements) for the entirety of Frame i and then begin encoding Frame i+1. When the VPP engine starts encoding Frame i+1, the one or more VSP engines may begin consuming the syntax elements for Frame i produced by the VPP engine and can produce an encoded video bitstream for Frame i. In other examples, the one or more VSP engines may begin processing Frame i before the VPP engine has moved on to Frame i+1. For example, the one or more VSP engines may begin processing encoded portions of Frame i before the VPP engine has completely encoded (e.g., produced syntax elements) for the entirety of Frame i. Communication of data between the VPP engine and the one or more VSP engines may be though on-chip memory or external DDR memory. In some examples, the memory comprises a ring buffer that allows the VPP engine and the one or more VSP engines to operate on different and potentially non-sequential frames of video data in parallel.

In scenario 500, video decoder 300 uses one or more VSP engines and a VPP engine to decode a Frame i of video data and a Frame i+1 of video data at least partially in parallel. For example, the one or more VSP engines and the VPP engine may operate on different frames of video data at the same time. While scenario 500 shows the one or more VSP engines operating one frame ahead (e.g., at Frame i+1) of the VPP engine, in other examples, the one or more VSP engines may operate several frames ahead of the VPP engine. Scenario 500 may be called a different frame mode of video decoding.

In scenario 500, the one or more VSP engines may completely decode (e.g., produce syntax elements) for the entirety of Frame i and then begin decoding Frame i+1. When the one or more VSP engines starts decoding Frame i+1, the VPP engine may begin consuming the syntax elements for Frame i produced by the one or more VSP engines and can produce decoded video data for Frame i. In other examples, the VPP engine may begin processing Frame i before the one or more VSP engines have moved on to Frame i+1. For example, the VPP engine may begin processing decoded portions of Frame i before the one or more VSP engines have completely decoded (e.g., produced syntax elements) for the entirety of Frame i. Again, communication of data between the VPP engine and the one or more VPP engines may be though on-chip memory or external DDR memory. In some examples, the memory comprises a ring buffer that allows the VPP engine and the one or more VSP engines to operate on different and potentially non-sequential frames of video data in parallel.

Scenario 400 and scenario 500 may be particular useful for high bitrate video applications that benefit from utilizing multiple VSP engines, such as video transcoding or editing, and other applications that involve multiple encoding and/or decoding sessions.

In general, video encoder 200 and video decoder 300 may include a plurality of VSP engines configured to process the video data at a syntax element level, a VPP engine configured to process the video data at a pixel level, and a controller. The controller is configured to control power of the VSP engines based on a comparison of VSP and VPP engine speeds for a video coding session. Specific examples of how the controller may power on and off one or more of the VSP engines are described in more detail below.

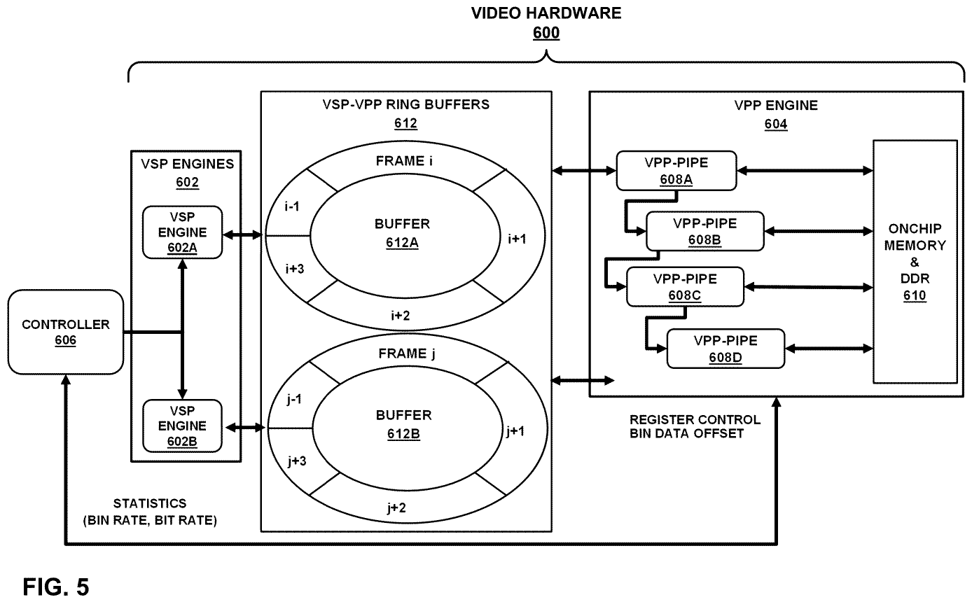

FIG. 5 is a block diagram illustrating an example of video hardware 600 including a plurality of VSP engines 602 (e.g., VSP engines 602A and 602B) and a VPP engine 604 configured to exchange data through one or more ring buffers 612 that allow VSP engines 202 and VPP engine 604 to operate on different and potentially non-sequential frames of video data in parallel. VSP engines 602 may operate at least partially in parallel with one another. For example, VSP engine 602A may operate on a frame of video data while VSP engine 602B is concurrently operating on a different frame of video data.

In the example of FIG. 5, a ring buffer is allocated to each of the VSP engines 602. That is, VSP engine 602A is allocated a ring buffer 612A, and VSP engine 602B is allocated a ring buffer 612B. However, in other examples, two or more of VSP engines 602 may share a ring buffer, or one of VSP engines 602 may be allocated two or more ring buffers. In some examples, at least one of the ring buffers 612 (e.g., ring buffer 612A or 612B) comprises a set of ring buffers. Accordingly, any reference herein to a “ring buffer” may describe a set of ring buffers.

VPP engine 604 may include a single VPP engine/pipe or a plurality of VPP engines/pipes (e.g., VPP pipes 608A-608D). In this regard, VPP engine 604 can also be configured to operate on two or more frames of video data at least partially in parallel, much like the VSP engines 602. In some examples, each of VPP pipes 608A-608D may contain transform, prediction, and filtering units. VPP engine 604 may also include or may be communicatively coupled to on-chip memory and/or DDR 610. In some examples, ring buffers 612 are allocated within on-chip memory and/or DDR 610 for information exchange between VSP engines 602 and VPP engine 604. Data in ring buffers 612 may be mathematically coded or compressed with binarization to reduce buffer size requirements.

Video hardware 600 can be generic to both a video encoder and a video decoder such that the order in which VSP engines 602 and VPP engine 604 process video data may be switched based on whether video hardware 600 is configured as a video encoder (e.g., see FIG. 2), or a video decoder (e.g., see FIG. 3). As described above, VSP engines 602 process video data at a syntax element level, handling tasks such as entropy coding. Meanwhile, VPP engine 604 processes video data at a pixel level, performing operations like prediction, transformation, and filtering.

Controller 606 may include any combination of hardware (e.g., processing circuitry), firmware, and/or software. For example, controller 606 may include processing circuity configured to operate according to firmware and/or execute a software driver. In examples, controller 606 interfaces with VSP engines 602, dynamically adjusting their power states based on a comparison of VSP and VPP engine speeds for a video coding session, as described in further detail below. Controller 606 may be configured to power on a selected number of VSP engines, and power off others, to ensure that the combined processing capability of active (i.e., powered on) ones of the VSP engines 602 aligns with the throughput of VPP engine 604. In this manner, the system may optimize resource utilization and reduce power consumption without sacrificing performance.

In examples, video hardware 600 may include a total of N VSP engines 602, where N is an integer greater than or equal to 2. Controller 606 may be configured to determine a VSP speed (Svsp), i.e., a processing speed, of one VSP engine of the N VSP engines 602 and a VPP speed (Svpp), i.e., a processing speed, of the VPP engine 604. In some examples, controller 606 may project Svsp and Svpp based on a video static performance model. For example, controller 606 may execute a video driver in software that includes a video static performance model to determine (e.g., calculate/estimate) Svsp and Svpp for a given bitstream. In some examples, Svsp and Svpp are measured in hardware cycles per frame, although other granularities may be appropriate depending on the workload scheduling techniques that are applied.

In one example, as simple video static performance model includes the following assumptions: VSP max speed is 200 Mbps (e.g., one VSP engine of the N VSP engines 602 may process 200 Million bits per second); VPP max speed is 100 cycles/MB (e.g., VPP engine 604 may process one 16×16 pixels macroblock per second); video hardware speed is 600 MHz. Based on this example static performance model, for an ultra-high definition (3840×2160 pixels) at 60 frames per second (UHD60) bitstream with a 62 Mbps bitrate, one VSP engine takes 186M (Million) cycles to finish 62M bits of a decoding session per second and VPP takes 194M cycles to finish UHD60 pixels of the decoding session per second. For example, controller 606 may calculate Svsp and Svpp as follows: Svsp=62 Mbps/200 Mbps*600 Mhz=186M cycles (to finish 62 Mbps decode); and Svpp=3840×2160*60/16/16*100/1000/1000=194M cycles (to finish UHD60 decode).

In general, VPP engine 604 may read out bin and/or bit data stored in ring buffers 612 and feedback the data to controller 606 through registers. Controller 606 then uses the bin and/or bit data to determine Svsp and Svpp. In some examples, controller 606 determines (e.g., derives and/or calculates) Svsp and Svpp based on a static performance model as described above. The video static performance model may comprise a mathematical representation that predicts how fast a video codec will compress static or mostly unchanging content within a video sequence, assessing its efficiency in handling scenes with minimal motion, like a still image within a video stream, by analyzing factors like pixel redundancy and spatial correlations.

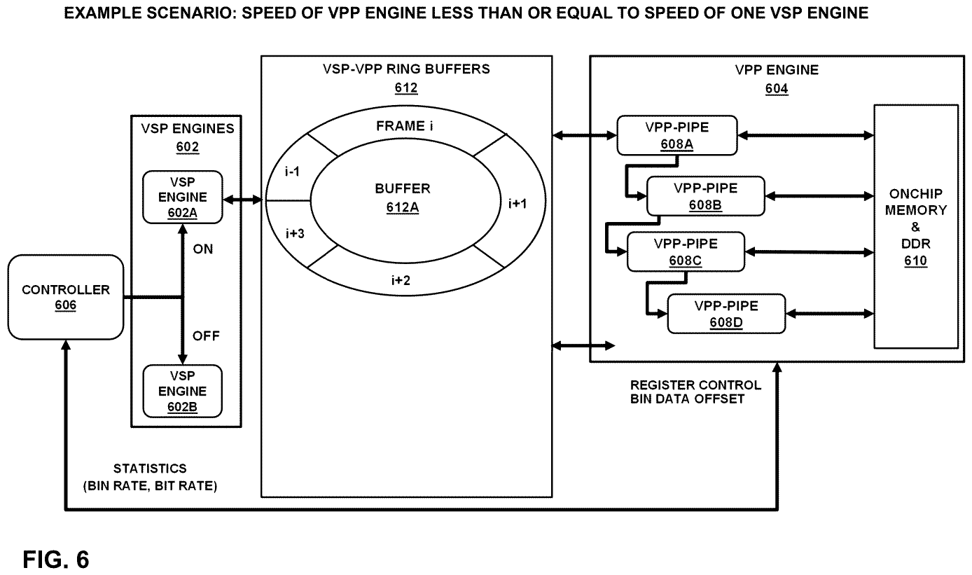

Controller 606 is configured to compare Svsp and Svpp and then control power of VSP engines 602 based on said comparison. For example, controller 606 may be configured to control power states of one or more of the VSP engines 602 based on a set of rules or conditions involving a comparison of Svsp and Svpp. FIGS. 6 through 8 illustrate example scenarios in which controller 606 selectively powers on or off one or more of the VSP engines 602 based on comparing Svsp and Svpp to determine which of the following conditions applies: (1) Svpp≤1*Svsp; (2) 1*Svsp<Svpp≤(N/2)*Svsp; (3) Svpp≥N*Svsp; or (4) (N/2)*Svsp<Svpp<N*Svsp.

FIG. 6 is a block diagram illustrating an example scenario of the video hardware 600 of FIG. 5 being controlled by controller 606 based on a processing speed of VPP engine 604 being less than or equal to a processing speed of one VSP engine (e.g., one of VSP engines 602) for a coding session. That is, Svpp≤1*Svsp. One VSP engine is fast enough to support VPP throughput for this scenario, which could be, for example, a low bitrate use case. Controller 606 may be configured to power on one VSP engine of the N VSP engines and power off other (i.e., N−1) VSP engines of the N VSP engines based on determining that Svpp≤1*Svsp. For example, controller 606 may power off VSP engine 602B, leaving only VSP engine 602A powered on.

As shown in FIG. 6, controller 606 may also allocate ring buffer 612A for VSP engine 602A and remove or re-allocate ring buffer 612B (not shown) because it is not being used by VSP engine 602B, since VSP engine 602B is in an inactive (powered off) state. In some examples, controller 606 may control on-chip memory and/or DDR 610 to remove or re-allocate unused ring buffers (e.g., ring buffer 612B). In general, controller 606 may allocate ring buffers 612 based on active VSP engines of the total number (N) of VSP engines 602.

In the example scenario of FIG. 6, VSP engine 602B is powered off, thereby reducing leakage current, and one ring buffer (ring buffer 612A) is allocated to VSP engine 602A. For decoding, ring buffer 612A may allow VSP engine 602A to move to a next frame (e.g., Frame i+1) while VPP engine 604 is processing a current frame (e.g., Frame i). Conversely, for encoding, ring buffer 612A may allow VPP engine 604 to process a next frame (e.g., Frame i+1) while VSP engine 602A is processing a current frame (e.g., Frame i).

In examples involving more than two VSP engines 602, it is possible for the processing speed of VPP engine 604 to be greater than the processing speed of one VSP engine bust still less than a processing speed of half the total number of VSP engines. Stated another way, 1*Svsp<Svpp≤(N/2)*Svsp. In this case, controller 606 may be configured to power on at least (N/2)+1 VSP engines of the N VSP engines and power off other (e.g., all remaining) VSP engines of the N VSP engines based on determining that 1*Svsp<Svpp≤(N/2)*Svsp. If there are an odd number of VSP engines, N may be rounded up the nearest even number for purposes of calculating the number of VSP engines to be powered on.

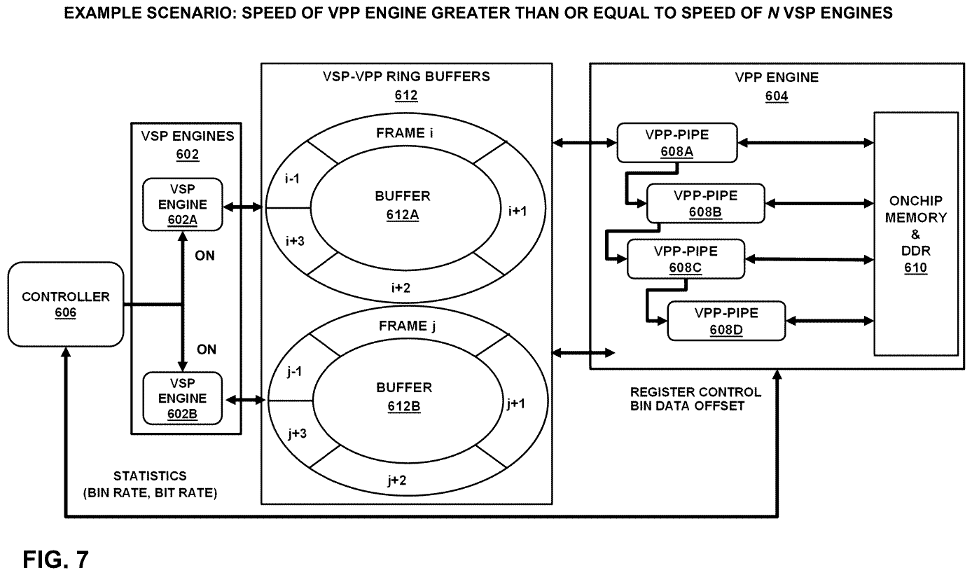

FIG. 7 is a block diagram illustrating an example scenario of the video hardware 600 of FIG. 5 being controlled by controller 606 based on a processing speed of VPP engine 604 being greater than or equal to a processing speed of the total number (N) of VSP engines 602. That is, Svpp≥N*Svsp. In this case (e.g., a high bitrate use case), VPP engine 604 outpaces VSP engines 602 even if all the VSP engines are active. Accordingly, controller 606 may be configured to power on all N of the VSP engines 602 based on determining that Svpp≥N*Svsp. In the example of FIG. 7, controller 606 powers on VSP engine 602A and VSP engine 602B. Controller 606 may also allocate ring buffers 612 for all N of the VSP engines 602. For example, in FIG. 7, controller 606 allocates ring buffer 612A for VSP engine 602A and ring buffer 612B for VSP engine 602B.

When multiple VSP engines are active, controller 606 may be configured to allocate portions of a coding session to VSP engines 602 in an interleaved manner. For instance, in the example of FIG. 7, controller may allocate portions of the coding session to VSP engines 602A and 602B such that VSP engine 602A works on even number frames (e.g., frames 0, 2, 4, 6, . . . ) and VSP engine 602B works on odd number frames (e.g., frames 1, 3, 5, 7, . . . ). In the example scenario of FIG. 7, VSP engines 602A and 602B are both active (i.e., powered on). For decoding, VSP engine 602A may send bin information for even number frames to ring buffer 612A (these frames may be referenced as Frame i, i+1, i+2, . . . ), and VSP engine 602B may send bin information for odd number frames to ring buffer 612B (these frames may be referenced as Frame j, j+1, j+2, . . . ). Conversely, for encoding, VSP engine 602A may consume bin information for even number frames from ring buffer 612A, and VSP engine 602B may consume bin information for odd number frames from ring buffer 612B. Additionally, for decoding, controller 606 may be configured to communicate (e.g., transmit) bin offset information to VPP engine 604 to consume bin information from ring buffers 612 by alternating between ring buffer 612A and ring buffer 612B. And for encoding, controller 606 may be configured to communicate (e.g., transmit) bin offset information to VPP engine 604 to send bin information to ring buffers 612 by alternating between ring buffer 612A and ring buffer 612B.

In other examples, another form of workload distribution may be appropriate so long as the workload is divided among VSP engines 602. Furthermore, controller 606 may allocate portions of coding sessions to VSP engines 602 according to a granularity different than the video frame-based scheduling that is described with respect to examples in FIGS. 6-8. For example, controller 606 may allocate portions of coding sessions to VSP engines 602 according to tile-based scheduling or another workload scheduling granularity. Depending on the workload scheduling that is applied, controller 606 may be configured to control VSP engines 602, VPP engine 604, and ring buffers 612 to send and/or consume bin data in a manner that conforms to the manner of workload distribution.

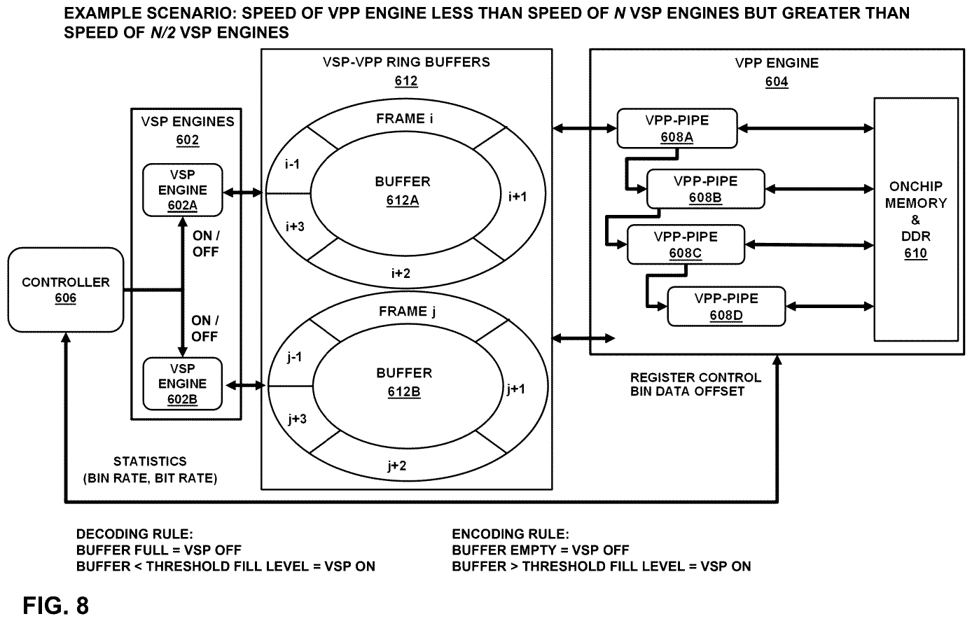

FIG. 8 is a block diagram illustrating an example scenario of the video hardware 600 of FIG. 5 being controlled by controller 606 based on a processing speed of VPP engine 604 being greater than a processing speed of half of the total number (N) of VSP engines 602 but less than a processing speed of all N of the VSP engines 602. That is, (N/2)*Svsp<Svpp<N*Svsp. In this case, VSP engines 602 will outpace VPP engine 604 if all the VSP engines are active, but VPP engine 604 can become a bottle neck if too many VSP engines are powered off. Since VSP engines 602 and VPP engine 604 exchange data through ring buffers 612, the fill level of ring buffers 612 is a good indicator of whether VSP engines 602 are outpacing VPP engine 604, or vice versa. Accordingly, controller 606 may be configured to selectively power on and off one or more VSP engines of the N VSP engines based on a fill level of at least one of the ring buffers 612 when it is determined that (N/2)*Svsp<Svpp<N*Svsp.

In the example of FIG. 8, controller 606 initially powers on VSP engine 602A and VSP engine 602B. Controller 606 may also allocate ring buffers 612 for all N of the VSP engines 602. For example, in FIG. 8, controller 606 allocates ring buffer 612A for VSP engine 602A and ring buffer 612B for VSP engine 602B.

As previously noted, when multiple VSP engines are active, controller 606 may be configured to allocate portions of a coding session to VSP engines 602 in an interleaved manner. For instance, in the example of FIG. 8, controller may allocate portions of the coding session to VSP engines 602A and 602B such that VSP engine 602A works on even number frames (e.g., frames 0, 2, 4, 6, . . . ) and VSP engine 602B works on odd number frames (e.g., frames 1, 3, 5, 7, . . . ). In the example scenario of FIG. 8, VSP engines 602A and 602B are both active (i.e., powered on). For decoding, VSP engine 602A may send bin information for even number frames to ring buffer 612A (these frames may be referenced as Frame i, i+1, i+2, . . . ), and VSP engine 602B may send bin information for odd number frames to ring buffer 612B (these frames may be referenced as Frame j, j+1, j+2, . . . ). Conversely, for encoding, VSP engine 602A may consume bin information for even number frames from ring buffer 612A, and VSP engine 602B may consume bin information for odd number frames from ring buffer 612B. Additionally, for decoding, controller 606 may be configured to communicate (e.g., transmit) bin offset information to VPP engine 604 to consume bin information from ring buffers 612 by alternating between ring buffer 612A and ring buffer 612B. And for encoding, controller 606 may be configured to communicate (e.g., transmit) bin offset information to VPP engine 604 to send bin information to ring buffers 612 by alternating between ring buffer 612A and ring buffer 612B.

In other examples, another form of workload distribution may be appropriate so long as the workload is divided among VSP engines 602. Furthermore, controller 606 may allocate portions of coding sessions to VSP engines 602 according to a granularity different than the video frame-based scheduling that is described with respect to examples in FIGS. 6-8. For example, controller 606 may allocate portions of coding sessions to VSP engines 602 according to tile-based scheduling or another workload scheduling granularity. Depending on the workload scheduling that is applied, controller 606 may be configured to control VSP engines 602, VPP engine 604, and ring buffers 612 to send and/or consume bin data in a manner that conforms to the manner of workload distribution.

In the example of FIG. 8, controller 606 powers on and off VSP engines 602A and 602B based on a fill level of ring buffer 612A and/or 612B. In some examples, all the VSP engines (e.g., both VSP engines 602A and 602B) are powered on or off based on a fill level of either ring buffer 612A or 612B. This may be appropriate if workload is substantially balanced across VSP engines 602A and 602B such that ring buffers 612A and 612B have the same or similar fill levels at any given time. In other examples, controller 606 may be configured to power on or off a VSP engine based on a fill level of a ring buffer allocated to that VSP engine. For example, VSP engine 602A may be powered on or off based on a fill level of ring buffer 612A and VSP engine 602B may be powered on or off based on a fill level of ring buffer 612B.

For decoding, if all N of the VSP engines 602 are active (e.g., VSP engines 602A and 602B are powered on), at certain time, ring buffers 612 may become full while VPP engine 604 is still working on current frame. To reduce leakage, controller 606 may be configured to power off one or more of the VSP engines 602, or all N of the VSP engines 602, when one or more of ring buffers 612, or all of the ring buffers 612, are full during a decoding session. Eventually, VPP engine 604 will catch up. Accordingly, controller 606 may be further configured to power one or more of the VSP engines 602, or all N of the VSP engines 602, back on when the fill level of one or more of ring buffers 612, or all of the ring buffers 612, is below a threshold fill level during a decoding session. For example, the threshold fill level could be one half, such that controller 606 powers one or more of the VSP engines 602, or all N of the VSP engines 602, back on when one or more of ring buffers 612, or all of the ring buffers 612, are less than half full.

For encoding, if all N of the VSP engines 602 are active (e.g., VSP engines 602A and 602B are powered on), at certain time, ring buffers 612 may become empty such that VSP engines 602 become idle due to lack of bin data to consume. To reduce leakage, controller 606 may be configured to power off one or more of the VSP engines 602, or all N of the VSP engines 602, when one or more of ring buffers 612, or all of the ring buffers 612, are empty during an encoding session. Eventually, VPP engine 604 will catch up. Accordingly, controller 606 may be further configured to power one or more of the VSP engines 602, or all N of the VSP engines 602, back on when the fill level of one or more of ring buffers 612, or all of the ring buffers 612, is above a threshold fill level during an encoding session. For example, the threshold fill level could be one half, such that controller 606 powers one or more of the VSP engines 602, or all N of the VSP engines 602, back on when one or more of ring buffers 612, or all of the ring buffers 612, are more than half full.

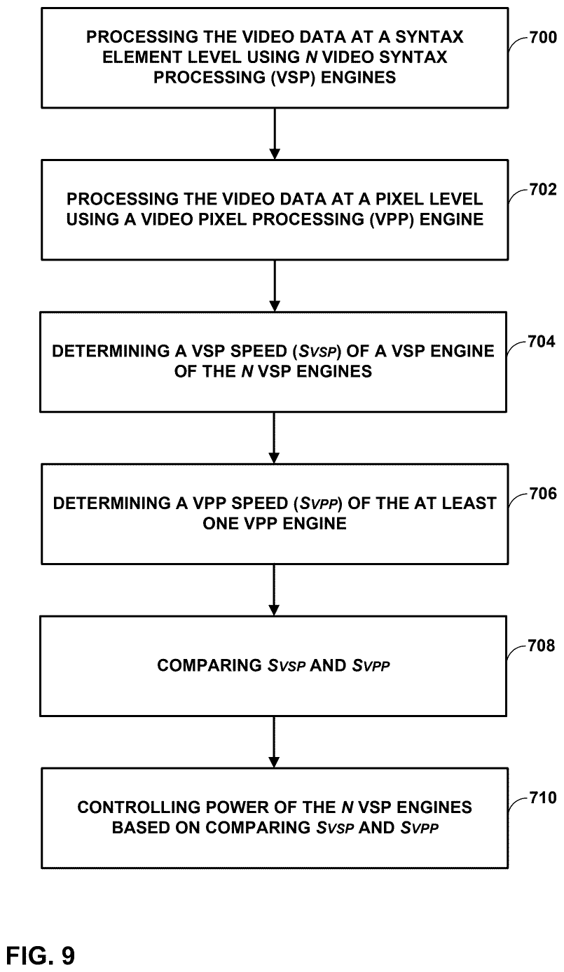

FIG. 9 is a flowchart illustrating an example of controlling power of one or more VSP engines based on a comparison of VSP and VPP engine speeds for a video coding session. The techniques of FIG. 9 may be performed by video hardware 600 and controller 606 of FIG. 5 or any other processing circuitry.

Video hardware 600 processes video data at a syntax element level using VSP engines 602 (700). In examples, N is the total number of VSP engines 602, where Nis an integer greater than or equal to 2. The N VSP engines 602 may operate at least partially in parallel with one another. For example, VSP engine 602A may operate on a frame of video data while VSP engine 602B is concurrently operating on a different frame of video data. VSP engines 602 may encode and decode syntax elements and include processing engines to perform arithmetic coding, such as CABAC.

Video hardware 600 processes video data at a pixel level using VPP engine 604 (702). VPP engine 604 may include a single VPP engine/pipe or a plurality of VPP engines/pipes (e.g., VPP pipes 608A-608D). In this regard, VPP engine 604 can also operate on two or more frames of video data at least partially in parallel, much like the VSP engines 602. VPP engine 604 may perform pixel processing and may include engines for transforms, prediction, filtering, and other processes at the pixel level.

In some examples, for video decoding, video hardware 600 may process video data at the syntax element level using VSP engines 602 (700) before video hardware 600 processes video data at the pixel level using VPP engine 604 (702); whereas, for video encoding, video hardware 600 may process video data at the pixel level using VPP engine 604 (702) before video hardware 600 processes video data at the syntax element level using VSP engines 602 (700). In either case, blocks 704-710 may be executed according to the example flow shown in FIG. 9 to control power of one or more VSP engines based on a comparison of VSP and VPP engine speeds for the video coding (i.e., decoding or encoding) session.

Controller 606 determines the VSP speed (Svsp) of one VSP engine of the N VSP engines 602 (704). Controller 606 also determines the VPP speed (Svpp) of VPP engine 604 (706). For example, controller 606 may project Svsp and Svpp based on a video static performance model. In some examples, Svsp and Svpp are measured in hardware cycles per frame, although other granularities may be appropriate depending on the workload scheduling techniques that are applied.

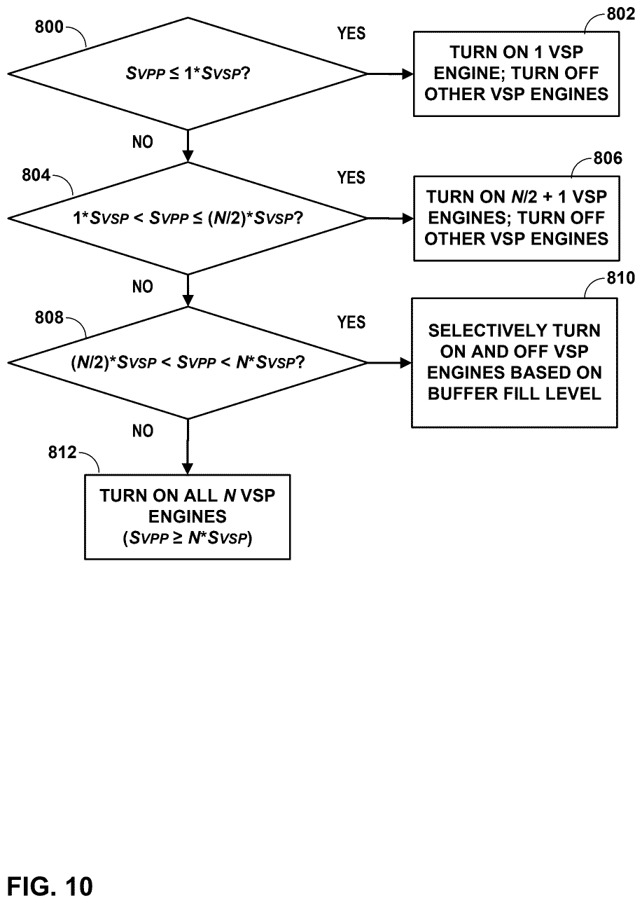

Controller 606 compares Svsp and Svpp (708) and then controls power of VSP engines 602 based on said comparison (710). For example, controller 606 may control power states of one or more of the VSP engines 602 based on a set of rules or conditions involving a comparison of Svsp and Svpp. FIGS. 6 through 8 illustrate example scenarios, which have been described above, in which controller 606 selectively powers on or off one or more of the VSP engines 602 based on comparing Svsp and Svpp to determine which of the following conditions applies: (1) Svpp≤1*Svsp; (2) 1*Svsp<Svpp≤(N/2)*Svsp; (3) Svpp≥N*Svsp; or (4) (N/2)*Svsp<Svpp<N*Svsp. Techniques for comparing Svsp and Svpp and controlling power of VSP engines 602 based on comparing Svsp and Svpp are also described below with reference to FIG. 10.

FIG. 10 is a flowchart illustrating an example of comparing VSP and VPP engine speeds for a video coding session and controlling power of one or more VSP engines based on said comparison. The techniques of FIG. 10 may be performed by controller 606 of FIG. 5 or any other processing circuitry.

In the example of FIG. 10, controller 606 determines whether Svpp≤1*Svsp (800). If Svpp≤1*Svsp, controller 606 powers on one VSP engine (e.g., VSP engine 602A) of the N VSP engines 602 and powers off other (e.g., all remaining (N−1)) VSP engines of the N VSP engines 602 based on determining that Svpp≤1*Svsp (802).

Otherwise, controller 606 determines whether 1*Svsp<Svpp≤(N/2)*Svsp (804). If 1*Svsp<Svpp≤(N/2)*Svsp, controller 606 powers on at least (N/2)+1 VSP engines of the N VSP engines 602 and powers off other (e.g., all remaining) VSP engines of the N VSP engines 602 based on determining that 1*Svsp<Svpp≤(N/2)*Svsp (806). In a system with only two VSP engines, steps 804 and 806 are optional.

If Svpp>(N/2)*Svsp, controller 606 determines whether (N/2)*Svsp<Svpp<N*Svsp (808). If (N/2)*Svsp<Svpp<N*Svsp, controller 606 selectively powers on and off one or more VSP engines of the N VSP engines based on a fill level of at least one buffer (810). Information (e.g., bin/bit data of video frames) may be stored within ring buffers 612 accessible to VSP engines 602 and VPP engine 604. In some examples, a ring buffer is allocated to each of the VSP engines 602. For example, ring buffer 612A allocated to VSP engine 602A and ring buffer 612B allocated to VSP engine 602B. Controller 606 may power on and off VSP engines 602 based on a fill level of ring buffers 612.

For decoding, if all N of the VSP engines 602 are active, at certain time, ring buffers 612 may become full while VPP engine 604 is still working on current frame. To reduce leakage, controller 606 may power off one or more of the VSP engines 602, or all N of the VSP engines 602, when one or more of ring buffers 612, or all of the ring buffers 612, are full during a decoding session. Eventually, VPP engine 604 will catch up. Accordingly, controller 606 may power one or more of the VSP engines 602, or all N of the VSP engines 602, back on when the fill level of one or more of ring buffers 612, or all of the ring buffers 612, is below a threshold fill level during a decoding session. For example, the threshold fill level could be one half, such that controller 606 powers one or more of the VSP engines 602, or all N of the VSP engines 602, back on when one or more of ring buffers 612, or all of the ring buffers 612, are less than half full.

For encoding, if all N of the VSP engines 602 are active, at certain time, ring buffers 612 may become empty such that VSP engines 602 become idle due to lack of bin data to consume. To reduce leakage, controller 606 may power off one or more of the VSP engines 602, or all N of the VSP engines 602, when one or more of ring buffers 612, or all of the ring buffers 612, are empty during an encoding session. Eventually, VPP engine 604 will catch up. Accordingly, controller 606 may power one or more of the VSP engines 602, or all N of the VSP engines 602, back on when the fill level of one or more of ring buffers 612, or all of the ring buffers 612, is above a threshold fill level during an encoding session. For example, the threshold fill level could be one half, such that controller 606 powers one or more of the VSP engines 602, or all N of the VSP engines 602, back on when one or more of ring buffers 612, or all of the ring buffers 612, are more than half full.

If Svpp≥N*Svsp (e.g., a high bitrate use case), VPP engine 604 outpaces VSP engines 602 even if all the VSP engines are active. Accordingly, controller 606 may power on all N of the VSP engines 602 based on determining that Svpp≥N*Svsp (812).

By dynamically configuring the VSP engines to match VPP processing speed, the video coding system maintains throughput requirements while minimizing power usage. For instance, when Svpp≤1*Svsp, VSP leakage (i.e., underutilization and unnecessary power consumption of VSP engines 602) can be reduced by one half in a system with two VSP engines or more in a system that includes more than two VSP engines. When Svpp≥N*Svsp, the system is still able to support high bitrate use cases as it normally would with VSP engines 602 operating in parallel (e.g., 2× bitrate with VSP engines 602A and 602B both powered on). When (N/2)*Svsp<Svpp<N*Svsp, VSP leakage (i.e., underutilization and unnecessary power consumption of VSP engines 602) may be reduced by approximately one and a half while approximately one and a half as much bitrate is supported when VSP engines 602 are selectively powered on and off based on the fill level of ring buffers 612 in a system with two VSP engines. Power savings and resource utilization may be higher in systems with more than two VSP engines.

The following numbered clauses illustrate one or more aspects of the devices and techniques described in this disclosure.

Clause 1. An apparatus configured to code video data comprises: N video syntax processing (VSP) engines configured to process the video data at a syntax element level, where N is an integer greater than or equal to 2; a video pixel processing (VPP) engine configured to process the video data at a pixel level; and a controller configured to: determine a VSP speed (Svsp) of one VSP engine of the N VSP engines; determine a VPP speed (Svpp) of the VPP engine; compare Svsp and Svpp; and control power of the N VSP engines based on comparing Svsp and Svpp.

Clause 2. The apparatus of clause 1, wherein the controller is configured to compare Svsp and Svpp by determining whether Svpp≤1*Svsp, and wherein the controller is configured to power on one VSP engine of the N VSP engines and power off other VSP engines of the N VSP engines based on determining that Svpp≤1*Svsp.

Clause 3. The apparatus of any of clauses 1 and 2, wherein the controller is configured to compare Svsp and Svpp by determining whether 1*Svsp<Svpp≤(N/2)*Svsp, and wherein the controller is configured to power on at least (N/2)+1 VSP engines of the N VSP engines and power off other VSP engines of the N VSP engines based on determining that 1*Svsp<Svpp≤(N/2)*Svsp.

Clause 4. The apparatus of any of clauses 1-3, wherein the controller is configured to compare Svsp and Svpp by determining whether Svpp≥N*Svsp, and wherein the controller is configured to power on the N VSP engines based on determining that Svpp≥N*Svsp.

Clause 5. The apparatus of any of clauses 1-4, further comprising at least one buffer that stores information about portions of the video data being processed by the N VSP engines and the VPP engine, wherein the controller is configured to compare Svsp and Svpp by determining whether (N/2)*Svsp<Svpp<N*Svsp, and wherein the controller is configured to selectively power on and off one or more VSP engines of the N VSP engines based on a fill level of the at least one buffer when it is determined that (N/2)*Svsp<Svpp<N *Svsp.

Clause 6. The apparatus of clause 5, wherein the controller is configured to power off the one or more VSP engines of the N VSP engines when the at least one buffer is full during a decoding session.

Clause 7. The apparatus of any of clauses 5 and 6, wherein the controller is configured to power on the one or more VSP engines of the N VSP engines when the fill level of the at least one buffer is below a threshold fill level during a decoding session.

Clause 8. The apparatus of any of clauses 5-7, wherein the controller is configured to power off the one or more VSP engines of the N VSP engines when the at least one buffer is empty during an encoding session.

Clause 9. The apparatus of any of clauses 5-8, wherein the controller is configured to power on the one or more VSP engines of the N VSP engines when the fill level of the at least one buffer is above a threshold fill level during an encoding session.

Clause 10. The apparatus of any of clauses 5-9, wherein the at least one buffer comprises at least one ring buffer.

Clause 11. A method for coding video data comprises: processing the video data at a syntax element level using N video syntax processing (VSP) engines, where N is an integer greater than or equal to 2; processing the video data at a pixel level using a video pixel processing (VPP) engine; determining a VSP speed (Svsp) of one VSP engine of the N VSP engines; determining a VPP speed (Svpp) of the VPP engine; comparing Svsp and Svpp; and controlling power of the N VSP engines based on comparing Svsp and Svpp.

Clause 12. The method of clause 11, wherein comparing Svsp and Svpp comprises determining whether Svpp≤1*Svsp, and wherein controlling power of the N VSP engines based on comparing Svsp and Svpp comprises powering on one VSP engine of the N VSP engines and powering off other VSP engines of the N VSP engines based on determining that Svpp≤1*Svsp.

Clause 13. The method of any of clauses 11 and 12, wherein comparing Svsp and Svpp comprises determining whether 1*Svsp<Svpp≤(N/2)*Svsp, and wherein controlling power of the N VSP engines based on comparing Svsp and Svpp comprises powering on at least (N/2)+1 VSP engines of the N VSP engines and powering off other VSP engines of the N VSP engines based on determining that 1*Svsp<Svpp≤(N/2)*Svsp.

Clause 14. The method of any of clauses 11-13, wherein comparing Svsp and Svpp comprises determining whether Svpp≥N*Svsp, and wherein controlling power of the N VSP engines based on comparing Svsp and Svpp comprises powering on the N VSP engines based on determining that Svpp≥N*Svsp.

Clause 15. The method of any of clauses 11-14, further comprising storing information about portions of the video data being processed by the N VSP engines and the VPP engine in at least one buffer, wherein comparing Svsp and Svpp comprises determining whether (N/2)*Svsp<Svpp<N*Svsp, and wherein controlling power of the N VSP engines based on comparing Svsp and Svpp comprises selectively powering on and off one or more VSP engines of the N VSP engines based on a fill level of the at least one buffer when it is determined that (N/2)*Svsp<Svpp<N*Svsp.

Clause 16. The method of clause 15, wherein selectively powering on and off the one or more VSP engines of the N VSP engines based on the fill level of the at least one buffer comprises powering off the one or more VSP engines of the N VSP engines when the at least one buffer is full during a decoding session.

Clause 17. The method of any of clauses 15 and 16, wherein selectively powering on and off the one or more VSP engines of the N VSP engines based on the fill level of the at least one buffer comprises powering on the one or more VSP engines of the N VSP engines when the fill level of the at least one buffer is below a threshold fill level during a decoding session.

Clause 18. The method of any of clauses 15-17, wherein selectively powering on and off the one or more VSP engines of the N VSP engines based on the fill level of the at least one buffer comprises powering off the one or more VSP engines of the N VSP engines when the at least one buffer is empty during an encoding session.

Clause 19. The method of any of clauses 15-18, wherein selectively powering on and off the one or more VSP engines of the N VSP engines based on the fill level of the at least one buffer comprises powering on the one or more VSP engines of the N VSP engines when the fill level of the at least one buffer is above a threshold fill level during an encoding session.

Clause 20. The method of any of clauses 15-19, wherein the at least one buffer comprises at least one ring buffer.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media may include one or more of RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

1. An apparatus configured to code video data, the apparatus comprising:
N video syntax processing (VSP) engines configured to process the video data at a syntax element level, where Nis an integer greater than or equal to 2;
a video pixel processing (VPP) engine configured to process the video data at a pixel level; and
a controller configured to:
determine a VSP speed (Svsp) of one VSP engine of the N VSP engines;
determine a VPP speed (Svpp) of the VPP engine;
compare Svsp and Svpp by determining whether Svpp≥N*Svsp; and
control power of the N VSP engines based on comparing Svsp and Svpp, wherein to control the power of the N VSP engines based on comparing Svsp and Svpp, the controller is configured to power on the W VSP engines based on determining that Svpp≥N*Svsp.

2. The apparatus of claim 1, wherein the controller is further configured to compare Svsp and Svpp by determining whether Svpp≤1*Svsp, and wherein, to control the power of the W VSP engines based on comparing Svsp and Svpp, the controller is further configured to power on one VSP engine of the N VSP engines and power off other VSP engines of the N VSP engines based on determining that Svpp≤1*Svsp.

3. The apparatus of claim 1, wherein the controller is further configured to compare Svsp and Svpp by determining whether 1*Svsp<Svpp≤(N/2)*Svsp, and wherein, to control the power of the W VSP engines based on comparing Svsp and Svpp. the controller is further configured to power on at least (N/2)+1 VSP engines of the N VSP engines and power off other VSP engines of the N VSP engines based on determining that 1*Svsp<Svpp≤(N/2)*Svsp.

4. (canceled)

5. The apparatus of claim 1, further comprising at least one buffer that stores information about portions of the video data being processed by the N VSP engines and the VPP engine, wherein the controller is further configured to compare Svsp and Svpp by determining whether (N/2)*Svsp<Svpp<N*Svsp, and wherein, to control the power of the N VSP engines based on comparing Svsp and Svpp, the controller is further configured to selectively power on and off one or more VSP engines of the N VSP engines based on a fill level of the at least one buffer when it is determined that (N/2)*Svsp<Svpp<N*Svsp.

6. The apparatus of claim 5, wherein the controller is configured to power off the one or more VSP engines of the N VSP engines when the at least one buffer is full during a decoding session.

7. The apparatus of claim 5, wherein the controller is configured to power on the one or more VSP engines of the N VSP engines when the fill level of the at least one buffer is below a threshold fill level during a decoding session.

8. The apparatus of claim 5, wherein the controller is configured to power off the one or more VSP engines of the N VSP engines when the at least one buffer is empty during an encoding session.

9. The apparatus of claim 5, wherein the controller is configured to power on the one or more VSP engines of the N VSP engines when the fill level of the at least one buffer is above a threshold fill level during an encoding session.

10. The apparatus of claim 5, wherein the at least one buffer comprises at least one ring buffer.

11. A method for coding video data, the method comprising:
processing the video data at a syntax element level using N video syntax processing (VSP) engines, where N is an integer greater than or equal to 2;
processing the video data at a pixel level using a video pixel processing (VPP) engine;
determining a VSP speed (Svsp) of one VSP engine of the N VSP engines;
determining a VPP speed (Svpp) of the VPP engine;
comparing Svsp and Svpp, wherein comparing Svsp and Svpp comprises determining whether Svpp≥N*Svsp; and
controlling power of the N VSP engines based on comparing Svsp and Svpp, wherein controlling the power of the N VSP engines based on comparing Svsp and Svpp comprises powering on the W VSP engines based on determining that Svpp≥N*Svsp.

12. The method of claim 11, wherein comparing Svsp and Svpp further comprises determining whether Svpp≤1*Svsp, and wherein controlling power of the N VSP engines based on comparing Svsp and Svpp further comprises powering on one VSP engine of the N VSP engines and powering off other VSP engines of the N VSP engines based on determining that Svpp≤1*Svsp.

13. The method of claim 11, wherein comparing Svsp and Svpp further comprises determining whether 1*Svsp<Svpp≤(N/2)*Svsp, and wherein controlling power of the N VSP engines based on comparing Svsp and Svpp further comprises powering on at least (N/2)+1 VSP engines of the N VSP engines and powering off other VSP engines of the N VSP engines based on determining that 1*Svsp<Svpp≤(N/2)*Svsp.

14. (canceled)

15. The method of claim 11, further comprising storing information about portions of the video data being processed by the N VSP engines and the VPP engine in at least one buffer, wherein comparing Svsp and Svpp further comprises determining whether (N/2)*Svsp<Svpp<N*Svsp, and wherein controlling power of the N VSP engines based on comparing Svsp and Svpp further comprises selectively powering on and off one or more VSP engines of the N VSP engines based on a fill level of the at least one buffer when it is determined that (N/2)*Svsp<Svpp<N*Svsp.

16. The method of claim 15, wherein selectively powering on and off the one or more VSP engines of the N VSP engines based on the fill level of the at least one buffer comprises powering off the one or more VSP engines of the N VSP engines when the at least one buffer is full during a decoding session.

17. The method of claim 15, wherein selectively powering on and off the one or more VSP engines of the N VSP engines based on the fill level of the at least one buffer comprises powering on the one or more VSP engines of the N VSP engines when the fill level of the at least one buffer is below a threshold fill level during a decoding session.

18. The method of claim 15, wherein selectively powering on and off the one or more VSP engines of the N VSP engines based on the fill level of the at least one buffer comprises powering off the one or more VSP engines of the N VSP engines when the at least one buffer is empty during an encoding session.

19. The method of claim 15, wherein selectively powering on and off the one or more VSP engines of the N VSP engines based on the fill level of the at least one buffer comprises powering on the one or more VSP engines of the N VSP engines when the fill level of the at least one buffer is above a threshold fill level during an encoding session.

20. The method of claim 15, wherein the at least one buffer comprises at least one ring buffer.

21. An apparatus configured to code video data, the apparatus comprising:
at least one memory; and
processing circuitry in communication with the at least one memory, the processing circuitry configured to:
process the video data at a syntax element level using N video syntax processing (VSP) engines, where Nis an integer greater than or equal to 2;
process the video data at a pixel level using a video pixel processing (VPP) engine;
determine a VSP speed (Svsp) of a VSP engine of the N VSP engines;
determine a VPP speed (Svpp) of the VPP engine;
compare Svsp and Svpp by determining whether Svpp≥N*Svsp; and
control power of the N VSP engines based on comparing Svsp and Svpp, wherein to control the power of the N VSP engines based on comparing Svsp and Svpp, the controller is configured to power on the N VSP engines based on determining that Svpp≥N*Svsp.
